(19) United States
(12) Patent Application Publication
(10) Pub. No.: US 2006/0029195 A1
(43) Pub. Date: Feb. 9, 2006

(54) Methods, apparatus and computer program products for message notification in a voice over internet protocol communication system

(76) Inventors: Karen Mullis, Loganville, GA (US); Anita Simpson, Decatur, GA (US)

Correspondence Address: David D. Beatty;Myers Bigel Sibley & Sajovec, P.A., P.O. Box 37428, Raleigh, NC, 27627, US

(21) Appl. No.: 10/920,516

(22) Filed: Aug. 18, 2004

(51) Int. Cl. H04M 1/64

(52) U.S. Cl. 379/88.17

(57) ABSTRACT

A method for providing message notification in a Voice Over Internet Protocol (VoIP) communication system includes: receiving an off-hook notification from a subscriber to the VoIP communication system; and generating an audible announcement to the subscriber responsive to the off-hook notification, wherein the audible announcement includes a verbal voice announcement adapted to indicate to the subscriber that a new message associated with the subscriber is waiting in the VoIP communication system. The method may further include: receiving a second off-hook notification from the subscriber when there are no messages associated with the subscriber in the VoIP communication system; and generating a second audible announcement to the subscriber responsive to the second off-hook notification, wherein the second audible announcement is different from the first audible announcement.

### FIELD OF THE INVENTION

The present invention relates to the field of telephony and, more particularly, to methods, apparatus and computer program products for providing message notification in a Voice Over Internet Protocol (VoIP) communication system.

### BACKGROUND OF THE INVENTION

The Internet has become a mainstream network for communicating not just data, such as email and pictures, but also for providing real-time bi-directional voice communications. Voice Over Internet Protocol (VoIP) is an industry standard that has evolved to enable users to place phone calls through the Internet, instead of through the Public Switched Telephone Network (PSTN). A conventional phone or other Consumer Premises Equipment (CPE) may now be connected to the Internet using an interface device that converts analog phone signals to digital signals that can be communicated through the Internet. A phone call may thereby be communicated through the Internet to a VoIP provider, who converts the call back to an analog signal and places the call through the PSTN that is local to the called phone. A user can thereby dial a telephone number in a conventional manner and have the call routed through the Internet, instead of through the PSTN.

The VoIP provider may have the ability to customize the audible signal presented to the user through the phone receiver when the receiver is taken “off-hook” (i.e., by picking up or otherwise initiating a call receive and/or dialing sequence). In order to distinguish a provider's digital service from Plain Old Telephone Service (POTS), providers may wish to play a distinctive tone or even a branded voice announcement instead of a conventional POTS dial tone to subscribers when they go off-hook. Typically, the branded voice announcement is designed to play immediately prior to a more traditional, PSTN-like dial tone.

A VoIP provider may also provide a voice or other messaging service to the subscriber. In a traditional PSTN-based voice or other messaging service, the subscriber is notified of the presence of a new message in the subscriber's mailbox by a Message Waiting Indication (MWI) which may include a visual indication and/or an audible indication. In the traditional PSTN-based service, the audible MWI is an interrupted, stuttered dial tone.

### SUMMARY OF THE INVENTION

According to method embodiments of the present invention, a method for providing message notification in a Voice Over Internet Protocol (VoIP) communication system includes: receiving an off-hook notification from a subscriber to the VoIP communication system; and generating an audible announcement to the subscriber responsive to the off-hook notification, wherein the audible announcement includes a verbal voice announcement adapted to indicate to the subscriber that a new message associated with the subscriber is waiting in the VoIP communication system. The method may further include: receiving a second off-hook notification from the subscriber when there are no messages associated with the subscriber in the VoIP communication system; and generating a second audible announcement to the subscriber responsive to the second off-hook notification, wherein the second audible announcement is different from the first audible announcement.

According to further embodiments of the present invention, a Voice Over Internet Protocol (VoIP) communication system is configured to: receive an off-hook notification from a subscriber to the VoIP communication system; and generate an audible announcement to the subscriber responsive to the off-hook notification, wherein the audible announcement includes a verbal voice announcement adapted to indicate to the subscriber that a new message associated with the subscriber is waiting in the VoIP communication system. The VoIP communication system may be further adapted to: receive a second off-hook notification from the subscriber when there are no new messages associated with the subscriber in the VoIP communication system; and generate a second audible announcement to the subscriber responsive to the second off-hook notification, wherein the second audible announcement is different from the first audible announcement.

According to further embodiments of the present invention, a computer program product for providing message notification in a Voice Over Internet Protocol (VoIP) communication system includes program code embodied in a computer-readable storage medium. The computer program code includes program code that is configured to: receive an off-hook notification from a subscriber to the VoIP communication system; and generate an audible announcement to the subscriber responsive to the off-hook notification, wherein the audible announcement includes a verbal voice announcement adapted to indicate to the subscriber that a new message associated with the subscriber is waiting in the VoIP communication system. The computer program product may further include program code that is configured to: receive a second off-hook notification from the subscriber when there are no new messages associated with the, subscriber in the VoIP communication system; and generate a second audible announcement to the subscriber responsive to the second off-hook notification, wherein the second audible announcement is different from the first audible announcement.

According to further method embodiments of the present invention, a method for providing message notification in a Voice Over Internet Protocol (VoIP) communication system includes: receiving an off-hook notification from a subscriber to the VoIP communication system; generating a first audible announcement to the subscriber responsive to the off-hook notification, wherein the first audible announcement is adapted to indicate to the subscriber that a new message associated with the subscriber is waiting in the VoIP communication system; and thereafter generating a second audible announcement to the subscriber, wherein the second audible announcement includes a verbal voice announcement.

According to embodiments of the present invention, a Voice Over Internet Protocol (VoIP) communication system is configured to: receive an off-hook notification from a subscriber to the VoIP communication system; generate a first audible announcement to the subscriber responsive to the off-hook notification, wherein the first audible announcement is adapted to indicate to the subscriber that a new message associated with the subscriber is waiting in the VoIP communication system; and thereafter generate a second audible announcement to the subscriber, wherein the second audible announcement includes a verbal voice announcement.

According to further embodiments of the present invention, a computer program product for providing message notification in a Voice Over Internet Protocol (VoIP) communication system includes program code embodied in a computer-readable storage medium. The computer program code includes program code that is configured to: receive an off-hook notification from a subscriber to the VoIP communication system; generate a first audible announcement to the subscriber responsive to the off-hook notification, wherein the first audible announcement is adapted to indicate to the subscriber that a new message associated with the subscriber is waiting in the VoIP communication system; and thereafter generate a second audible announcement to the subscriber, wherein the second audible announcement includes a verbal voice announcement.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a Voice Over Internet Protocol (VoIP) communication system according to embodiments of the present invention that may be used to provide telephone and messaging services, and that may communicate with PSTN communication equipment via a Public Switched Telephone Network (PSTN) and/or with VoIP communication equipment via a packet switched data network such as the Internet.

FIG. 2 is a block diagram of exemplary VoIP communication equipment including an analog phone that may be employed in the VoIP communication system of FIG. 1.

FIG. 3 is a flow chart illustrating operations for providing new message indication to a VoIP communication system subscriber in accordance with various embodiments of the present invention.

FIG. 4 is a flow chart illustrating operations for providing new message indication to a VoIP communication system subscriber in accordance with various embodiments of the present invention.

FIG. 5 is a flow chart illustrating operations for providing new message indication to a VoIP communication system subscriber in accordance with various embodiments of the present invention.

### DETAILED DESCRIPTION OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art.

Like numbers refer to like elements throughout the description. It will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

Except where noted herein, designations of “first, “second,” “third,” etc. do not indicate an order or hierarchy of steps or elements.

The present invention may be embodied as methods, apparatus, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described below with reference to block diagrams and/or operational illustrations of methods, apparatus, and computer program products. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, “off-hook” means the user sends a signal to a network or an interface device (e.g., an IAD) via a user interface to make a call or use a network feature. A VoIP communication device may be placed in an off-hook condition by, for example, lifting a phone receiver, enabling a phone speaker, pressing a feature button, clicking on an appropriate PC softclient function key, etc. According to some embodiments, it is not required that a receiver or the like be physically lifted or moved to place the equipment in an off-hook condition.

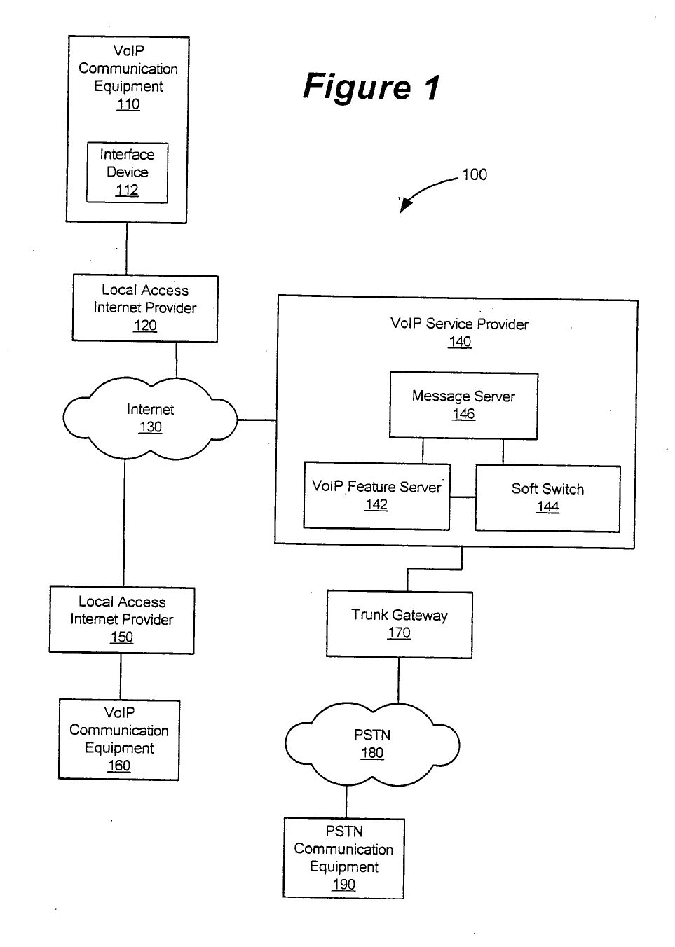

FIG. 1 is a block diagram of a Voice Over Internet Protocol (VoIP) communication system 100 according to various embodiments of the present invention that may be used to provide telephone and message storage and retrieval services (e.g., voice, email, and/or facsimile messages). In particular, the system 100 may be used to provide voice message storage and retrieval services. The exemplary VoIP communication system 100 includes a VoIP service provider 140 that can communicate with PSTN communication equipment 190 via a Public Switched Telephone Network (PSTN) 180 and with VoIP communication equipment 110 and VoIP communication equipment 160 via the Internet 130. The VoIP communication system 100 enables phone calls to be initiated and/or received by the VoIP communication equipment 110, the VoIP communication equipment 160, and/or the PSTN communication equipment 190 via the Internet 130, and such phone calls are referred to as VoIP phone calls. It is to be understood that the Internet 130 referred to herein may be any packet switched data network.

The VoIP communication system 100 may include local access internet providers 120 and 150 that respectively connect the VoIP communication equipment 110 and the VoIP communication equipment 160 with the Internet 130. The VoIP communication system 100 also includes the VoIP service provider 140 that is connected to the Internet 130 and is connected to the PSTN 180 via a trunk gateway 170. The local access Internet providers 120 and/or 150 may be, for example, a local telephone company that provides access to the Internet 130 through a dial-up connection and/or through a digital subscriber line (DSL), a cable TV/communications company that provides a cable modem connection to the Internet 130, and/or a wireless operator that provides cellular data communications to the Internet 130 over a wireless interface.

The VoIP communication equipment 110 and the VoIP communication equipment 160 may be of the same or different construction. The VoIP communication equipment 110 may be a computer with a microphone, speaker, and software that is configured to convert voice to/from a digital format that can be routed through the Internet 130. For example, the VoIP communication equipment 110 may be a conventional telephone that is connected through a VoIP interface device that is configured to convert voice to/from a digital format that can be routed through the Internet 130. For example, the VoIP communication equipment 110 may be an analog phone paired with an analog telephone adaptor (ATA), a gateway (e.g., a CPE gateway), or a similar analog-to-digital converter to convert the analog signal to a suitable digital (e.g., SIP-based) signal. The ATA may be or form a part of an integrated access device (IAD). Alternatively, the VoIP communication equipment 110 may be a digital or IP telephone (e.g., an SIP-based digital telephone), a soft phone or a firm phone. According to some embodiments, the equipment 110 and/or the equipment 160 is consumer premises based equipment (CPE).

According to some embodiments, the communication equipment 110 includes an interface device 112 that is capable of receiving messages or digital signals from the VoIP service provider 140 and responding to the VoIP service provider 140 and/or executing actions corresponding to the signals. The interface device may be an intelligent device and may include suitable components and software, firmware, etc. to enable and execute the features and operations described herein. The interface device 112 may have announcement capability and include one or more audible announcements stored therein. The interface device 112 may be operative to play those audible announcements via the receiver, speaker, headset, etc., of the equipment 110 as discussed hereinbelow. The interface device 112 may form a part of an ATA (e.g., an IAD) or other gateway connected to an analog phone or may form a part of a digital telephone.

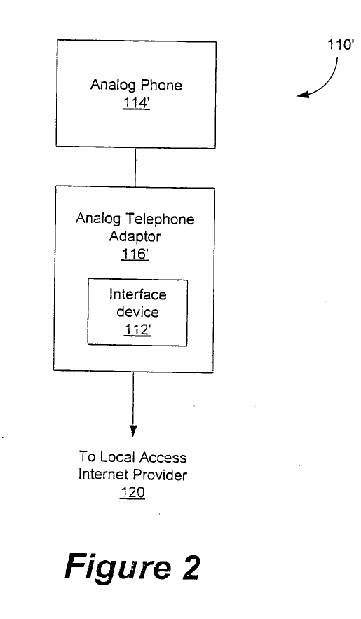

With reference to FIG. 2, VoIP communication equipment 110′ according to certain embodiments of the present invention and which may be advantageously employed for the VoIP communication equipment 110 in the system 100 is shown therein. The equipment 110′ includes an analog phone 114′ that is connected to the local access internet provider 120 by an analog telephone adaptor (ATA) 116′ or other suitable gateway device. An interface device 112′ corresponding to the interface device 112 forms an operational part of the ATA 116′. The ATA 116′ or other suitable gateway device may perform voice digitization and packetization of analog signals from the analog phone 114′ to convert the analog signals into IP telephony messages, and may convert the IP telephony message from the VoIP service provider 140 to analog signals for play through the analog phone 114′. The ATA 116′ may be an IAD. Various components and functions of the ATA 116′ may be embodied in separate devices. The entirety of the VoIP communication equipment 110′ may be located on the customer's or subscriber's premises.

A subscriber may set up VoIP services by registering with the VoIP service provider 140 and being assigned one or more VoIP telephone numbers. The VoIP service provider 140 can then route phone calls from/to the VoIP telephone number(s) assigned to the subscriber based on a called telephone number (i.e., the telephone number to which the phone call is directed). For example, the VoIP service provider 140 may route and establish a phone call from the VoIP communication equipment 110 and/or 160 through the respective local access internet provider 150 and 120 and the Internet 130, and through the trunk gateway 170 and the PSTN 180 to the PSTN communication equipment 190. The PSTN communication equipment 190 may be a conventional Plain Old Telephone Service (POTS) telephone.

The VoIP service provider 140 can include a VoIP feature server 142, a soft switch 144, and a message server 146. The VoIP feature server 142 may include, for example, a suitable platform, and can include subscriber information used for routing calls to/from subscribers. The message server 146 can include stored subscriber messages and a directory. The soft switch 144 can provide a bridge between the Internet 130 and the trunk gateway 170 and/or equipment in the PSTN 180. The VoIP feature server 142 and/or the soft switch 144 may perform one or more of the operations for routing and establishing VoIP phone calls. The message server 146 and/or the soft switch 144 may perform one or more operations for receiving, storing, retrieving, sending, modifying and/or managing messages such as voicemail, email, and/or facsimile messages. The message server 146 may include message mailboxes associated with respective subscribers.

Although FIG. 1 illustrates exemplary VoIP communication equipment 110, 160, a VoIP communication system 100, and a PSTN 180 and communication equipment, it will be understood that the present invention is not limited to such a configuration, but is intended instead to encompass any configuration capable of carrying out the operations described herein. For example, although only a single VoIP service provider 140, VoIP feature server 142, soft switch 144, message server 146, and trunk gateway 170 have been shown for illustration purposes, it will be understood that the VoIP communication system 100 would generally route phone calls to/from thousands of VoIP subscribers through numerous servers, switches, and trunk gateways. Moreover, it is to be understood that the VoIP communication equipment 110, the VoIP communication equipment 160 and/or the PSTN communication equipment 190 may communicate with a local access Internet provider and/or a VoIP service provider across a wireless interface such as, for example, a cellular interface (e.g., General Packet Radio System (GPRS), Enhanced Data Rates for Global Evolution (EDGE), Global System for Mobile Communications (GSM)), a wireless local area network interface (e.g., WLAN, IEEE 802.11), a Bluetooth interface, another RF communication interface, and/or an optical interface.

For the purposes of illustration, the message handling and notification features provided by the VoIP service provider 140 will be described with reference to a registered subscriber accessing the system 100 via the VoIP communication equipment 110. The subscriber subscribes to a messaging service of the VoIP service provider and a message mailbox is associated with the subscriber by the VoIP service provider 140. In particular, the subscriber may subscribe to a voice messaging service. The message mailbox may reside in the message server 146, for example. The messaging service and the VoIP service provider 140 will thereafter serve to receive, store, retrieve and play (in case of voice messages) messages directed to the subscriber's message mailbox. The messaging service may be of any suitable structure and operation. The establishment and operation of such VoIP messaging services and mailboxes are well-known to those of skill in the art and therefore will not be detailed herein.

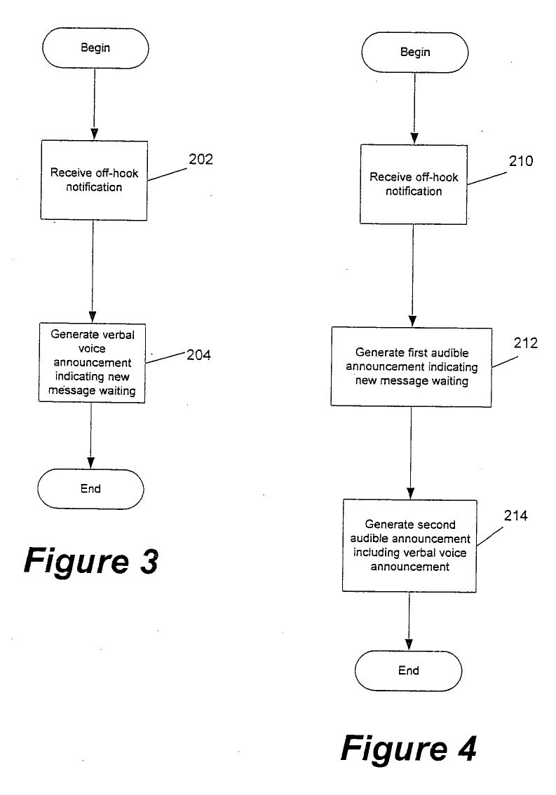

FIG. 3 is a flow chart illustrating method embodiments and operations of a VoIP communication system according to various embodiments of the present invention. In the illustrated embodiments, the VoIP communication system receives off-hook notification from the subscriber (Block 202). The off-hook notification may be initiated by triggering a switch (e.g., by lifting a handset), or any other suitable technique, such methods and mechanisms being well-known to those of ordinary skill in the art. Responsive to the off-hook notification, an audible announcement is generated to the subscriber (Block 204). The audible announcement includes a verbal voice announcement adapted to indicate to the subscriber that a new message associated with the subscriber is waiting in the VoIP communication system 100.

FIG. 4 is a flow chart illustrating further method embodiments and operations of a VoIP communication system according to various embodiments of the present invention. In the illustrated embodiments, the VoIP communication system receives off-hook notification from the subscriber (Block 210). Responsive to the off-hook notification, a first audible announcement is generated to the subscriber (Block 212). The first audible announcement is adapted to indicate to the subscriber that a new message associated with the subscriber is waiting in the VoIP communication system. The first audible announcement may or may not include a verbal voice announcement. The first audible announcement may be a stuttered dial tone. Following the generation of the first audible announcement, a second audible announcement is generated to the subscriber (Block 214). The second audible announcement includes a verbal voice announcement. According to some embodiments, the second audible announcement includes marketing information such as a name (e.g., a brand name).

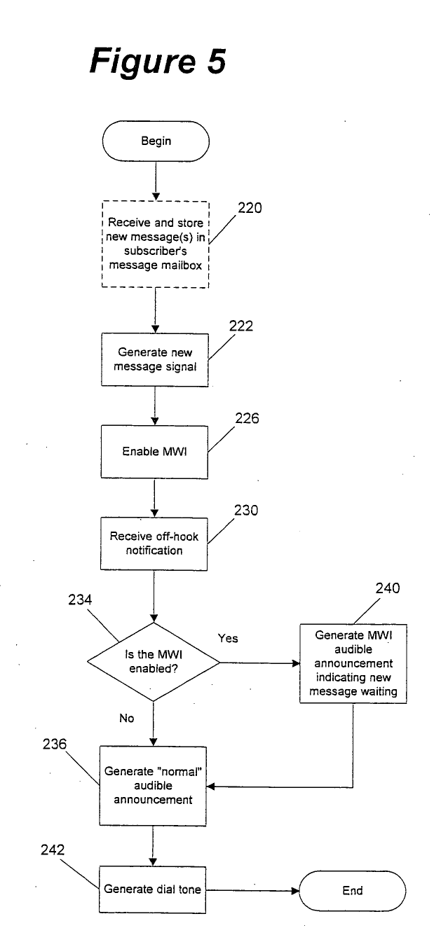

FIG. 5 is a flow chart illustrating method embodiments and operations of a VoIP communication system according to more particular embodiments of the present invention. In use, the subscriber's message mailbox receives and stores messages deposited therein by callers via the system 100 (Block 220). For example, the messages may be left by a caller from the VoIP communication equipment 160 and/or the PSTN communication equipment 190. Messages may also be deposited in the message mailbox by the VoIP service provider 140. According to some embodiments, the messages are sent to the VoIP service provider 140 as digital signals. The VoIP service provider 140 may receive and store voice, email and/or facsimile messages associated with the subscriber. In FIG. 5, the Block 220 is shown in dashed lines because, for any given execution of the method, there may in fact be no new messages received and stored.

When the VoIP service provider 140 receives a new message (e.g., a voice, email, or facsimile message) for the subscriber, the VoIP service provider 140 generates a digital signal to the VoIP communication equipment 110 to notify the equipment 110 that there is a new message awaiting the subscriber (Block 222). The new message signal serves to enable the message waiting indicator function of the equipment 110 (Block 226). This operation may be referred to as “pushing down” the message waiting indication to the equipment 110. For example, the VoIP service provider 140 may send the signal to the interface device 112 (e.g., as a SIP NOTIFY message), and the interface device 112 may be triggered thereby to enable or activate its MWI feature(s) (i.e., the audible announcement features as described herein and, if provided, a visual MWI). The VoIP service provider 140 may generate a new message signal for each new message received or may only generate a new message signal when a new message arrives and there are no other new messages in the subscriber's message mailbox.

Similarly, when all of the new messages have been converted to non-new messages (e.g., the messages have been listened to, deleted, and/or saved by the user), the VoIP service provider 140 may generate a digital signal to the VoIP communication equipment 110 indicating that there are no new messages in the subscriber's message mailbox. The interface device 112 may be triggered thereby to disable or deactivate its MWI feature(s).

Suitable methods for identifying new messages in a VoIP service provider and signaling an interface device to enable or disable one or more MWI's (visual and/or audible) are well known to those of skill in the art and therefore will not be described herein in detail. For example, methods and apparatus according to embodiments of the present invention may employ known techniques and apparatus for providing a stuttered dial tone MWI in consumer premises equipment (CPE), with suitable modifications in accordance with the inventions described herein.

The subscriber thereafter places the VoIP communication equipment 110 in an off-hook condition (e.g., by lifting a handset or initiating a software application) so that the interface device 112 receives an off-hook status notification as described above (Block 230).

Responsive to the off-hook notification, the VoIP communication equipment 110 (e.g., via the interface device 112) generates one of multiple available audible announcements. The appropriate announcement is selected depending on the status of the MWI feature of the VoIP communication equipment 110 (Block 234).

If the MWI feature is not enabled (i.e., because there are no new messages waiting), the VoIP communication equipment 110 generates or plays a “normal” or primary audible announcement (Block 236) to the subscriber (e.g., through the receiver). The normal audible announcement is not adapted to indicate to the subscriber that a new message is present in the subscriber's message mailbox.

The normal audible announcement may be any suitable announcement. The normal audible announcement may be a conventional, normal continuous dial tone, for example. The normal audible announcement may be a tone that is unique or distinctive and/or a signature tone that serves to identify the VoIP service provider or a brand or service of the VoIP service provider. According to some embodiments, the normal audible announcement is a verbal announcement (i.e., oral and including words) and may be referred to as a normal voice announcement. The normal voice announcement may be customized to recite a brand (e.g., the name of a service provider or a service) and/or other marketing information. For example, the normal voice announcement may state, “Welcome to the BellSouth Voice Over IP service”. The verbal announcement of the normal voice announcement may be accompanied by music or other non-verbal sound(s). The normal voice announcement may be interrupted when the subscriber initiates a further operation (e.g., dials digits to initiate a call or accesses the message mailbox or another feature provided by the VoIP service provider 140, etc.) or the call is timed out or otherwise terminated. The normal voice announcement may be followed by a traditional dial tone.

If the MWI feature is enabled (i.e., because there are one or more new messages waiting), the VoIP communication equipment 110 generates a message waiting indicator (MWI) audible announcement (Block 240) to the subscriber (e.g., through the receiver). The MWI audible announcement is adapted to indicate to the subscriber that a new message is present in the subscriber's message mailbox.

The MWI audible announcement may be any suitable announcement and may be regarded as the new message waiting announcement. According to some embodiments, the MWI audible announcement is a verbal announcement (i.e., oral and including words) and may be referred to as an MWI voice announcement. The MWI voice announcement may recite a message indicating the presence of the new message(s). For example, the MWI voice announcement may state, “You have a new message waiting”. The MWI voice announcement may recite additional information regarding the condition of the mailbox such as reciting the number of new messages present in the mailbox (e.g., reciting “You have three new messages waiting”) and/or reciting the type(s) of messages (e.g., reciting “You have two new faxes and one new email waiting”). The MWI voice announcement may be customized to recite a brand (e.g., the name of a service provider or a service) and/or other marketing information. For example, the MWI voice announcement may state, “You have a new message in your BellSouth Voice Over IP message mailbox”. The verbal announcement of the MWI voice announcement may be accompanied by music or other non-verbal sound(s).

The MWI voice announcement may be interrupted when the subscriber initiates a further operation (e.g., dials digits to initiate a call or accesses the message mailbox or another feature provided by the VoIP service provider 140, etc.) or the call is timed out or otherwise terminated. Alternatively, the MWI voice announcement may be played a prescribed number of times (e.g. once), after which the VoIP communication equipment 110 may play the normal audible announcement (Block 236) followed by a third audible announcement to the subscriber such as a traditional dial tone. Alternatively, the third audible announcement (e.g., a dial tone) may be played without playing the normal audible announcement.

According to some embodiments, the MWI announcement is a voice announcement as described above and is followed by a stuttered dial tone. According to some embodiments, the normal announcement is also a voice announcement as described above.

According to some embodiments, the MWI announcement is a non-verbal announcement and the normal announcement is a voice announcement as described above and, when a new message is present, the VoIP communication equipment 110 generates the non-verbal new message waiting announcement and thereafter the voice announcement of the normal announcement. According to some embodiments, the non-verbal announcement is an interrupted, stuttered dial tone.

The audible announcements as described above may be permanently or temporarily stored in the VoIP communication equipment 110 (e.g., in the interface device 112). One or more of the audible announcements may be preloaded, periodically downloaded from the VoIP service provider 140 or selectively downloaded from the VoIP service provider 140 (e.g., with each or selected new message notification announcements).

If one or more new messages are present in the mailbox, the VoIP communication equipment 110 may also actuate a visual element such as a blinking light. Typically, the visual element will be automatically actuated and de-actuated responsive to the “new message” and “no new message” signals from the VoIP service provider 140 without awaiting off-hook or other notification from the subscriber.

The subscriber may thereafter initiate any desired available operation. For example, the subscriber may retrieve the new and/or other messages from the message mailbox (e.g., by entering the appropriate numbers or the like), dial a number to initiate a telephone call, or terminate the session by placing the VoIP communication equipment 110 back on hook. The VoIP service provider 140 may include Interactive Voice Response (IVR) software with which the user may correspond. It will be appreciated that the subscriber may terminate the operations illustrated in FIG. 5 before completion by prematurely terminating the session (e.g. by returning the VoIP communication equipment to on hook status).

The VoIP communication equipment 110 may be configured to facilitate access to the subscriber's voicemail when in the new message waiting mode (i.e., MWI enabled). According to some embodiments, the VoIP equipment 110 is adapted such that, when the equipment 110 is in the new message waiting mode (i.e. the MWI is enabled), the interface device 112 will respond to a prescribed input by the subscriber (e.g., pressing a key or string of keys) by automatically initiating access to the subscriber's voice message mailbox. If the initial input from the subscriber does not match any such prescribed input, the interface device 112 may process the input(s) in the usual default manner. In accordance with some embodiments, such equipment 110 may be further adapted such that, when the equipment is not in the new message waiting mode (i.e., MWI is disabled), the interface device 112 will not respond to the prescribed input to automatically initiate access to the subscriber's voice message mailbox. Restated, the automatic or short cut access feature of the equipment 110 may be enabled and disabled in accordance with the MWI status.

The VoIP service provider 140 and the VoIP communication equipment 110 may communicate using any suitable protocol. According to some embodiments, they communicate using Session Initiation Protocol (SIP), H.323 and/or MGCP. Other suitable protocols will be apparent to those skilled in the art in view of the description herein.

Systems, methods and computer program products in accordance with the present invention may provide a number of benefits and advantages. If no new messages are awaiting the subscriber, the VoIP communication equipment 110 may provide its “normal” audible announcement. The subscriber will thereby be promptly exposed to the normal audible announcement and can readily initiate a call or other action. The user need not listen through the entirety of the normal audible announcement to see if the VoIP communication equipment 110 will issue a subsequent notification of a new message. On the other hand, if a new message is waiting, the subscriber will receive a prompt or immediate indication or alert of the same. The MWI audible announcement may be adapted to provide clear and intuitive information (e.g., it may state in plain language that a new message is waiting) so that the user need not interpret the intent of the audible indication. This may be particularly advantageous in the case of VoIP communication equipment 110 that is not provided with a visual MWI feature, which is frequently the case with VoIP communication equipment 110 including analog phones.

According to further embodiments, a third or further audible announcements may precede or follow each of the normal and MWI audible announcements.

While in methods and apparatus as described above the MWI feature is embodied in the VoIP communication equipment 110 (e.g., in the interface device 112), it will be appreciated that other configurations and methods can be employed in accordance with embodiments of the present invention. For example, the VoIP communication equipment 110 may generate an off-hook status signal to the VoIP service provider 140 when the VoIP communication equipment 110 is placed in an off-hook condition, causing the VoIP service provider 140 to determine whether there are any new messages waiting and then generate a corresponding signal to the VoIP communication equipment 110 to cause the corresponding one of the normal and MWI audible announcements to be played through the VoIP communication equipment 110 to the subscriber. Rather than storing the audible announcements on the VoIP communication equipment 110, they may be embodied in the reply signals from the VoIP service provider 140, which are played by the VoIP communication equipment 110 with or without translation or interpretation by the VoIP communication equipment 110.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed:

1. A method for providing message notification in a Voice Over Internet Protocol (VoIP) communication system, the method comprising:
a) receiving an off-hook notification from a subscriber to the VoIP communication system; and
b) generating an audible announcement to the subscriber responsive to the off-hook notification, wherein the audible announcement includes a verbal voice announcement adapted to indicate to the subscriber that a new message associated with the subscriber is waiting in the VoIP communication system.

2. The method of claim 1 including generating a digital signal from a VoIP service provider, the digital signal corresponding to the audible announcement.

3. The method of claim 2 including, prior to receiving the off-hook notification, sending the digital signal to a VoIP interface device associated with the subscriber.

4. The method of claim 1 including:
a) receiving a second off-hook notification from the subscriber when there are no new messages associated with the subscriber in the VoIP communication system; and
b) generating a second audible announcement to the subscriber responsive to the second off-hook notification, wherein the second audible announcement is different from the first audible announcement.

5. The method of claim 4 including generating the second audible announcement after the first audible announcement responsive to the first off-hook notification.

6. The method of claim 4 wherein the second audible announcement includes a second verbal voice announcement.

7. The method of claim 1 wherein the verbal voice announcement includes marketing information.

8. The method of claim 1 including enabling an automatic access feature of an interface device associate with the VoIP communication system when there is a new message associated with the subscriber waiting in the VoIP communication system, wherein, when the automatic access feature is enabled, the interface device is responsive to a prescribed input from the subscriber to automatically access a message mailbox in the VoIP communication system.

9. The method of claim 1 wherein the verbal voice announcement includes an indication of the number of new messages associated with the subscriber in the VoIP communication system.

10. A Voice Over Internet Protocol (VoIP) communication system configured to:
a) receive an off-hook notification from a subscriber to the VoIP communication system; and
b) generate an audible announcement to the subscriber responsive to the off-hook notification, wherein the audible announcement includes a verbal voice announcement adapted to indicate to the subscriber that a new message associated with the subscriber is waiting in the VoIP communication system.

11. The VoIP communication system of claim 10 including:
a) a VoIP service provider adapted to determine whether there is a new message associated with the subscriber in the VoIP communication system and to generate a corresponding digital signal; and
b) a VoIP interface device associated with the subscriber and adapted to generate the audible announcement to the subscriber based on the digital signal.

12. The VoIP communication system of claim 11 wherein the VoIP interface device is adapted to receive and store the digital signal prior to receiving the off-hook notification.

13. The VoIP communication system of claim 11 wherein the VoIP interface device includes an automatic access feature and is adapted to enable the automatic access feature when there is a new message associated with the subscriber waiting in the VoIP communication system, wherein, when the automatic access feature is enabled, the interface device is responsive to a prescribed input from the subscriber to automatically access a message mailbox in the VoIP communication system.

14. The VoIP communication system of claim 11 including an analog phone operatively connected to the interface device, and wherein the interface device is adapted to generate the audible announcement to the subscriber through the analog phone.

15. The VoIP communication system of claim 10 wherein the VoIP communication device is further adapted to:
a) receive a second off-hook notification from the subscriber when there are no new messages associated with the subscriber in the VoIP communication system; and
b) generate a second announcement to the subscriber responsive to the second off-hook notification, wherein the second audible announcement is different from the first audible announcement.

16. The VoIP communication system of claim 15 wherein the VoIP communication device is further adapted to generate the second audible announcement after the first audible announcement responsive to the first off-hook notification.

17. The VoIP communication system of claim 15 wherein the second audible announcement includes a second verbal voice announcement.

18. The VoIP communication system of claim 10 wherein the verbal voice announcement includes marketing information.

19. The VoIP communication system of claim 10 wherein the verbal voice announcement includes an indication of the number of new messages associated with the subscriber in the VoIP communication system.

20. A computer program product for providing message notification in a Voice Over Internet Protocol (VoIP) communication system, the computer program product comprising program code embodied in a computer-readable storage medium, the computer program code comprising:
program code that is configured to:
a) receive an off-hook notification from a subscriber to the VoIP communication system; and
b) generate an audible announcement to the subscriber responsive to the off-hook notification, wherein the audible announcement includes a verbal voice announcement adapted to indicate to the subscriber that a new message associated with the subscriber is waiting in the VoIP communication system.

21. The computer program product of claim 20 further including program code that is configured to:
a) receive a second off-hook notification from the subscriber when there are no new messages associated with the subscriber in the VoIP communication system; and
b) generate a second audible announcement to the subscriber responsive to the second off-hook notification, wherein the second audible announcement is different from the first audible announcement.

22. A method for providing message notification in a Voice Over Internet Protocol (VoIP) communication system, the method comprising:
a) receiving an off-hook notification from a subscriber to the VoIP communication system;
b) generating a first audible announcement to the subscriber responsive to the off-hook notification, wherein-the first audible announcement is adapted to indicate to the subscriber that a new message associated with the subscriber is waiting in the VoIP communication system; and thereafter
c) generating a second audible announcement to the subscriber, wherein the second audible announcement includes a verbal voice announcement.

23. The method of claim 22 wherein the verbal voice announcement includes marketing information.

24. The method of claim 22 wherein the first audible announcement includes a stuttered dial tone.

25. The method of claim 22 including enabling an automatic access feature of an interface device associate with the VoIP communication system when there is a new message associated with the subscriber waiting in the VoIP communication system, wherein, when the automatic access feature is enabled, the interface device is responsive to a prescribed input from the subscriber to automatically access a message mailbox in the VoIP communication system.

26. A Voice Over Internet Protocol (VoIP) communication system configured to:
a) receive an off-hook notification from a subscriber to the VoIP communication system;
b) generate a first audible announcement to the subscriber responsive to the off-hook notification, wherein the first audible announcement is adapted to indicate to the subscriber that a new message associated with the subscriber is waiting in the VoIP communication system; and thereafter
c) generate a second audible announcement to the subscriber, wherein the second audible announcement includes a verbal voice announcement.

27. The VoIP communication system of claim 26 wherein the verbal voice announcement includes marketing information.

28. The VoIP communication system of claim 26 wherein the first audible announcement includes a stuttered dial tone.

29. The VoIP communication system of claim 26 including a VoIP interface device, wherein the VoIP interface device includes an automatic access feature and is adapted to enable the automatic access feature when there is a new message associated with the subscriber waiting in the VoIP communication system, and wherein, when the automatic access feature is enabled, the interface device is responsive to a prescribed input from the subscriber to automatically access a message mailbox in the VoIP communication system.

30. A computer program product for providing message notification in a Voice Over Internet Protocol (VoIP) communication system, the computer program product comprising program code embodied in a computer-readable storage medium, the computer program code comprising:
program code that is configured to:
a) receive an off-hook notification from a subscriber to the VoIP communication system;
b) generate a first audible announcement to the subscriber responsive to the off-hook notification, wherein the first audible announcement is adapted to indicate to the subscriber that a new message associated with the subscriber is waiting in the VoIP communication system; and thereafter
c) generate a second audible announcement to the subscriber, wherein the second audible announcement includes a verbal voice announcement.
